(19) United States
(12) Patent Application Publication
(10) Pub. No.: US 2024/0420235 A1
(43) Pub. Date: Dec. 19, 2024

(54) COMMODITY-BACKED NFT TOKENS AND DUAL TOKENS

(71) Applicant: APP CATS LLC, Minneapolis, MN (US)

(72) Inventors: Bradley Charles GEER, Minneapolis, MN (US); Kristin Michelle GEER, Minneapolis, MN (US)

(21) Appl. No.: 18/745,167

(22) Filed: Jun. 17, 2024

Related U.S. Application Data
(63) Continuation-in-part of application No. 18/373,943, filed on Sep. 27, 2023.
(60) Provisional application No. 63/521,453, filed on Jun. 16, 2023.

(51) Int. Cl. G06Q 40/04

(52) U.S. Cl. CPC G06Q 40/04; G06Q 2220/00

(57) ABSTRACT

Disclosed herein are a system and method including a platform that administers a mobile app that allows user to participate in obtaining and trading non-fungible tokens (NFTs). In particular an embodiment includes a trust certificate that is attached to a NFT, where the certificate is both detachable and redeemable for its pro rata share of the net asset value of an associated trust. In yet another embodiment, a dual-purpose certificate is attached to a NFT that is divisible.

### RELATED APPLICATIONS

The present patent application claims priority from U.S. Provisional Patent Application No. 63/521,453, filed Jun. 16, 2023, and also is a continuation-in-part of U.S. patent application Ser. No. 18/373,943, filed Sep. 27, 2023 which claims priority from US Provisional Patent Application 63,377,273, filed Sep. 27, 2022. All of the foregoing application are incorporated by reference in their entirety herein.

### BACKGROUND

Collecting aggregated consumer data for advertising, market demographic, and other commercial or academic purposes has become extremely difficult due to consumer privacy laws, including General Data Rights Protection Agency (GDPR) and California Consumer Privacy Act (CCPA). The curtailment of mobile application (app) usage tracking following the introduction by Apple of the iOS14.5 mobile operating system that allows users to “opt-out” of being tracked contributes to this difficulty. For example, iOS14.5 allows users to “opt out” of being tracked. In many cases, mobile phone app users would readily consent to providing some information in exchange for a reward. This is not the same as being tracked. Also, providers of mobile apps in many cases would be eager to have access to the information that consenting mobile users provide. Currently, there is no facility for enabling mobile app users and mobile app providers to consensually supply data via a central platform.

### BRIEF DESCRIPTION OF THE DRAWINGS

FIG. 1 is a diagram of Mobile Application Data Collection System according to an embodiment.

FIG. 2 is a diagram of a CrowdDATA network topology according to an embodiment.

FIG. 3 is a diagram of a CrowdDATA enterprise edition network topology according to an embodiment.

FIG. 4 is a flow chart of a CrowdDATA reward process according to an embodiment.

FIG. 5 is a flow chart of CrowdDATA onboarding according to an embodiment.

FIGS. 6A and 6B are screen shots of mobile applications illustrating the gamification of the question and answer process according to an embodiment.

FIGS. 7A and 7B are screen shots of a mobile application reward store via CrowdDATA integration according to an embodiment.

FIGS. 8A and 8B are screen shots of a mobile application engagement leader board via CrowdDATA integration according to an embodiment.

FIG. 9 is diagram illustrating NFT CrowdCOIN tokens backed by trust certificate according to an embodiment.

FIG. 10 is diagram illustrating NFT CrowdCOIN tokens backed by commodity-redeemable tokens according to an embodiment.

FIG. 11 is diagram illustrating NFT CrowdCOIN dual tokens according to an embodiment.

### DETAILED DESCRIPTION

Disclosed herein are a method and system for mobile application data collection and reward. Providers of mobile applications (apps) utilize a plug-in that facilitates receiving data from app users and rewarding app users for their data. The method and system avoid user data blocking that might exist on some mobile platforms, as well various privacy laws such as GDPR, CCPA, etc., without doing anything illegal.

A CrowdDATA™ plug-in running on the CrowdDATA™ network provides a solution for web and mobile app providers that directly compensates app users who voluntarily wish to provide verified, anonymized data and interact with advertiser or other commercial content- and stores that data by interacting with servers on the CrowdDATA™ Network where it can be accessed for a fee by commercial or other organizations.

The plug-in solution facilitates data gathering and rewarding app users for their data. In an embodiment users redeem earned tokens for rewards with the app provider in a closed ecosystem. App providers are also rewarded with tokens for hosting question, data royalties, and/or providing users with services and products. Due to financial security regulations there may be separate reward (user) tokens and data (app provider) tokens.

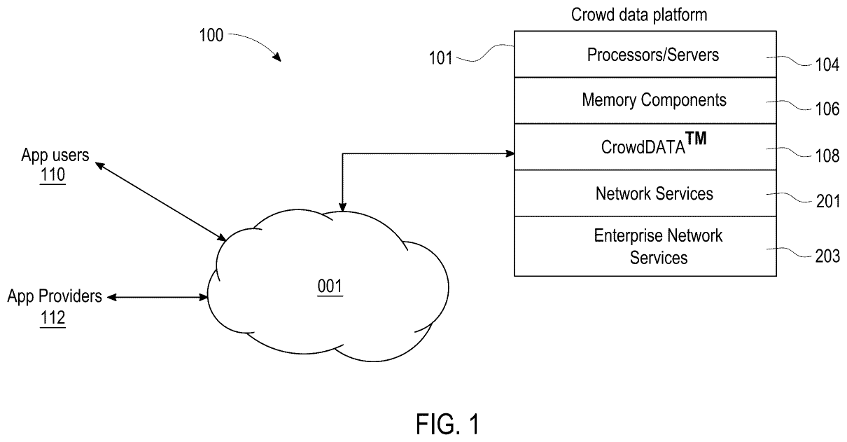

FIG. 1 is a diagram of Mobile Application Data Collection System 100 according to an embodiment. A platform 101 for performing the methods described herein is also referred to herein as the CrowdDATA™ platform, or “the platform”. Platform 101 includes multiple processor/servers 104, and multiple memory components 106. It is understood that the computing hardware and software associated with platform 101 may be distributed physically and virtually as is known in the art.

CrowdDATA™ plug-in 108 is a plug-in that can be integrated into mobile apps, as well as websites. Plug-in 108 interfaces with servers 104 that deploy data collected from app users to a CrowdDATA™ network that encompasses network services 201 and enterprise network services 203. Network services 201 and enterprise network services 203 are also referred to herein as the CrowdDATA™ network, or “the network”.

Plug-in 108 allows organizations to perform data queries across all previously collected CrowdDATA™ on the network, and to engage with those app users that fit their search criteria, either through advertisement, other forms of content, or smaller focus groups using a multi-directional CrowdLIVE™ streaming feature (not specifically described herein).

App users 110 and app providers 112 communication with the platform 101 via the internet 001 or any other facility to remotely communicate electronically between devices capable of such communication.

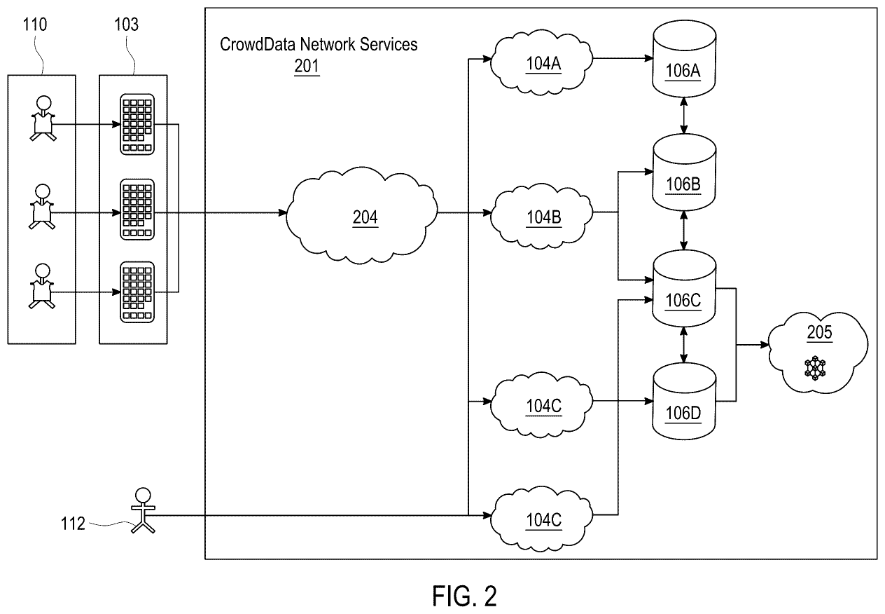

FIG. 2 is a diagram of a CrowdDATA™ network topology according to an embodiment.

CrowdDATA™ network services 201 include Plug-In 204 which interacts with mobile phones 103 Of users 110. CrowdDATA™ network services also include various servers 104, including authentication server 104A, question and response server 104B, reward server 104C, and data market server 104D.

As shown in the diagram, the various servers 104 interact with various CrowdDATA™ 106 databases, including user authentication database 106A, question database 106B, response database 106C, and reward database 106D.

App provider 112 interacts with data market server 104D.

Databases 106 C and 106D also communicate with blockchain reward token service 205.

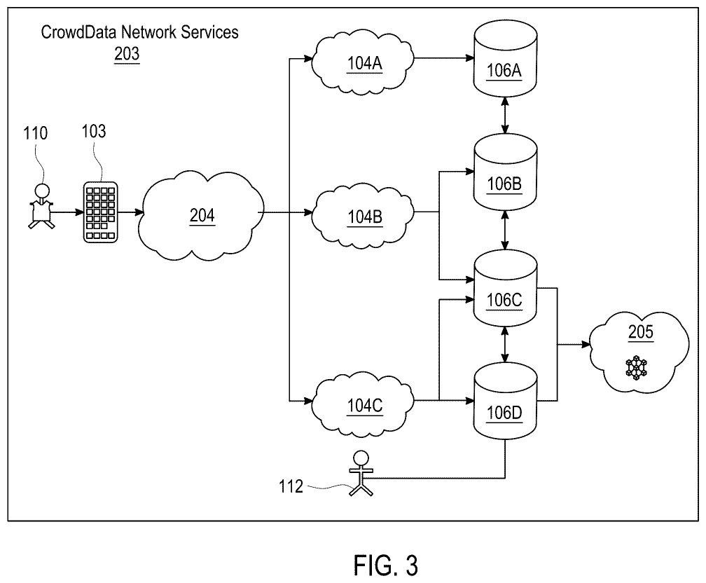

FIG. 3 is a diagram of a CrowdDATA™ enterprise edition network topology according to an embodiment. CrowdDATA™ enterprise network services 203 interacts with app users 110. A user 110 accesses the network services 203 via a mobile device 103, although it is understood that access can also be accomplished via a web site. Plug-in 204 is the interface between the user 110 and the user's device or other means of accessing the network services 203 though the platform 101.

In this enterprise case. the app provider 112 communicates with the reward database 106D within the network services 203. The plug-in 204 allows the user 110 to access the question and response server 104B as in FIG. 2. However, in this case, the app provider has more direct access to the reward data base 106D.

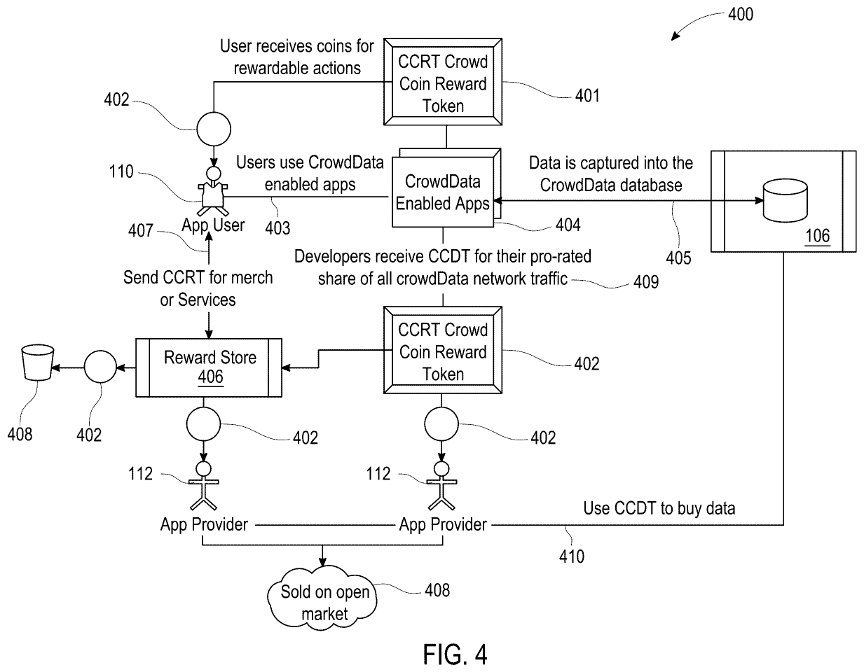

FIG. 4 is a flow chart of a CrowdDATA™ reward process 400 according to an embodiment. A user 110 can access (403) CrowdDATA™ enabled apps 404. From there user 110 can earn rewards 401, which include Crowd Coin Reward™ tokens 402. In the same transaction, data is captured 405 from the interaction and stored in the CrowdData™ database 106.

The user 110 can spend 407 the CCRT 402 (CrowdCoin™ reward token (hereinafter “token 402”) for merchandise or services at the rewards store 406. If not converted, tokens 402 can be stored in storage 408.

Developers receive a pro-rated share of all network traffic (see 409) in tokens 402.

App providers 112 also receive tokens 402 and generate tokens 402. App providers may participate in selling or buying tokens 402 on the open market 412. App providers 112 and also use tokens 402 to buy data (see 410).

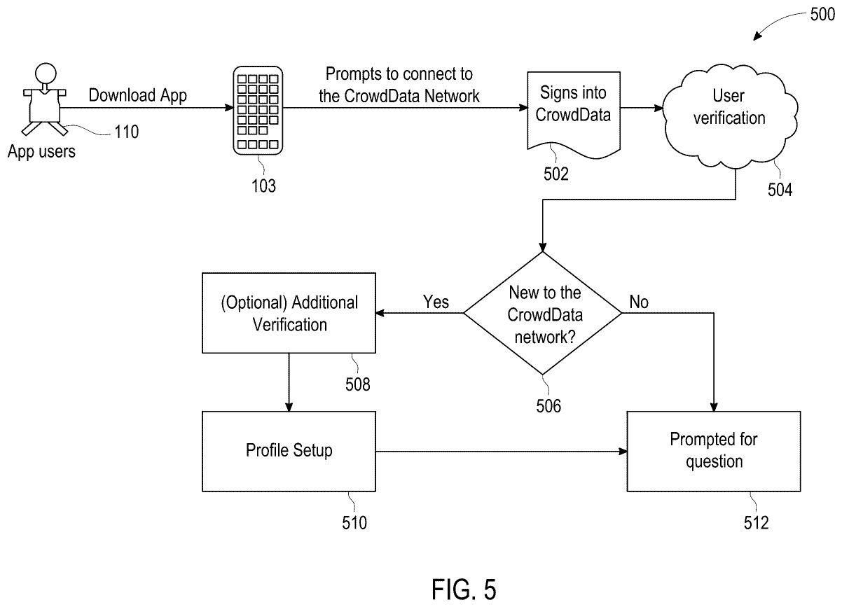

FIG. 5 is a flow chart 500 of CrowdDATA™ onboarding according to an embodiment. A user 110 downloads an app to a mobile phone 103 and is prompted to connect to the CrowdDATA™ network. The user then signs in (502) and undergoes user verification 504. At 506 it is determined whether the user is new to the network. If the user is not new to the network, the user is prompted for a question (512).

If the user is new to the network, the user is asks for additional verification (508) and prompted to set up a profile (510). After the profile is setup, the user can be prompted for a question (512).

Questions are served to users based on a variety of factors, including but not limited to:
app usage frequency;
app dictated question break;
app provider preference;
question priority;
question time sensitivity;
question integrity; and
user response rate.

In terms of question categories, question range from demographic to behavioral. For example:
Base level Data
gender, location, age, education, income, etc.;

### Participation Data

event attendance across sports and entertainment
hobby activities;

### Consumption Data

brand preferences
food and beverage preferences;

### Entertainment Data

Team affiliation
viewing habits
wagering history;

### App Provider Directed Questions; and

Other specific Surveys.

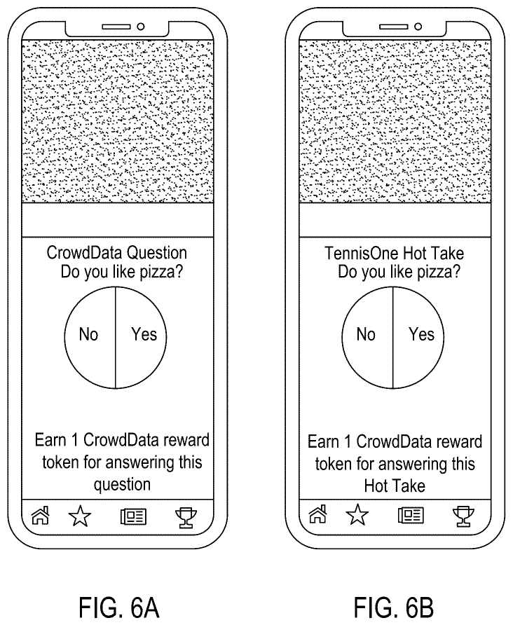

FIGS. 6A and 6B are screen shots of mobile applications illustrating the gamification of the question and answer process according to an embodiment. FIG. 6A shows a mobile phone screen with a CrowdDATA™ question-“do you like pizza?”. As shown the user can earn a token for answering the question. FIG. 6B illustrates a particular branded mobile app (in this case TennisONE. The question is posed as a TennisONE HOT TAKE. Again, the user can earn a token for answering the question. The objective is to keep questions simple and direct, and a non-traditional question interface is provided to prevent the user from feeling that answering is a chore. As shown, app branding is allowed for while still indicating CrowdDATA™ reward token payouts.

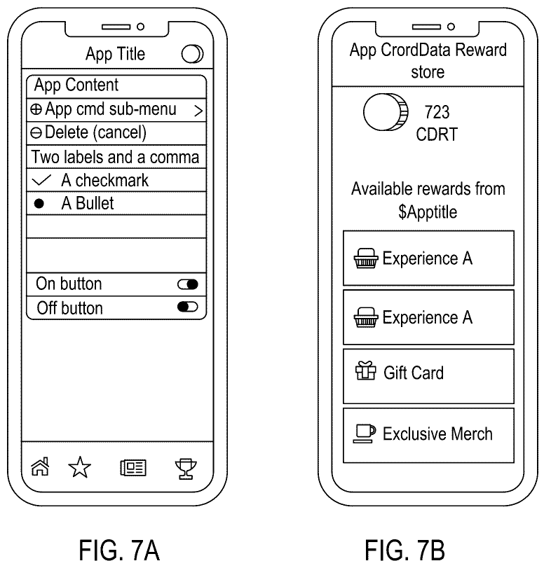

FIGS. 7A and 7B are screen shots of a mobile application reward store via CrowdDATA™ integration according to an embodiment. From the screen in FIG. 7A, the user can tap on the token icon to be taken to the screen in FIG. 7B where tokens can be redeemed. App providers can increase token income by providing app users with services, experiences, or physical products. In an embodiment, the app provider payout is based on the amount of CrowdDATA™ reward tokens consumed and the lifetime value of the user as well as network conditions.

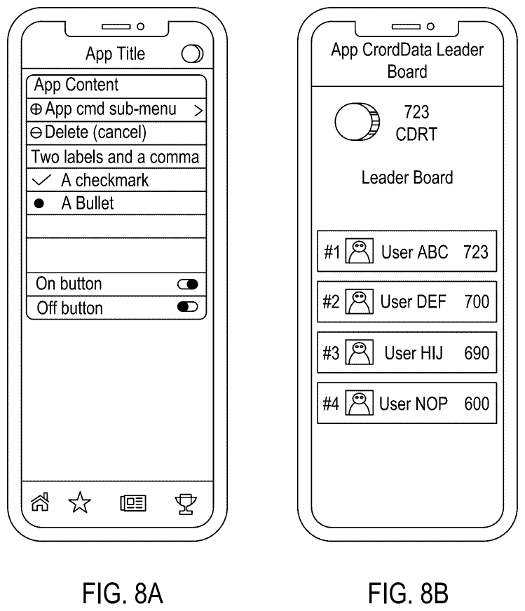

FIGS. 8A and 8B are screen shots of a mobile application engagement leader board via CrowdDATA integration according to an embodiment. App providers opting not to provide a reward store experience have a drop-in engagement leaderboard serving as the CrowdDATA™ homepage in their app. In FIG. 8A, which shows a screen of the app (which is not titled, but generically labeled App Title), a user can click on the token icon to bring up the screen in FIG. 8B, which shows a list of users and how many tokens they have accumulated.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

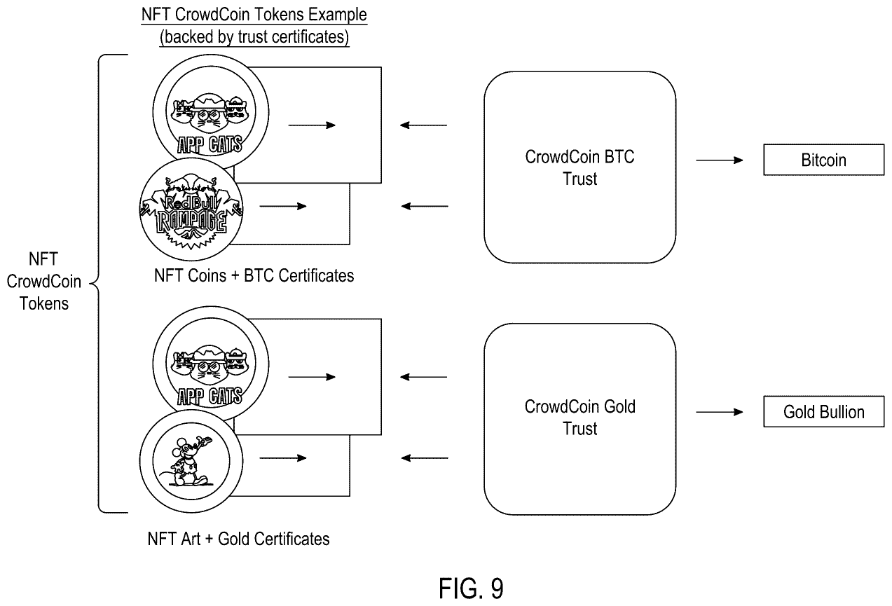

FIGS. 9, 10, and 11 illustrate an embodiment in which the platform administers a mobile app that allows user to participate in obtaining and trading non-fungible tokens (NFTs). In particular an embodiment includes a trust certificate that is attached to a NFT, where the certificate is both detachable and redeemable for its pro rata share of the net asset value of an associated trust.

An alternative embodiment embeds a NFT into a Bitcoin or other crypto coin using ordinals as an avenue to maintain the integrity of the coin on the blockchain while creating a space between the Bitcoin hashes to enable a NFT image, video or other digital file that is readily integrated by the platform.

In yet another embodiment, a dual-purpose certificate is attached to a NFT that is divisible into two primary component forms of value that are detachable and that split the value of a quantum of the assets in the trust in two, with a fixed base component and a variable upside piece. For example: 1) A Base unit, which would be worth the first $[25,000] of value of one Bitcoin (BTC) (1 BTC has trades for $60,000 today, and recently $70,000 recently); and 2) The Base unit value should remain largely stable over time and allow it to be used as a future medium of exchange, unlike BTC itself. This creates a stable-type coin that isn't reliant on the US dollar.

A Top unit represents all of the value of a BTC above $ [12,000]; this will vary daily as the market fluctuates and, therefore, is more speculative in nature. The NFT is attached to the Top unit specifically.

Typically digital tokens—whether fungible or non-fungible—have a lack of underlying inherent value to support their trading prices in the market. For example, of the 8,925 cryptocurrencies tracked by Investing.com, only ˜1% had a USD equivalent value of greater than $1.00 and ˜60% have a value less than $0.01 as of March 2023.

The described embodiment addresses this problem through the use of commodity-backed digital tokens attached to NFT art in the form of unique collectible coin series, creates a new way to combine a storage of value in the form of a certificated interest in Bitcoin, gold, silver or other precious metal or commodity held in-trust attached to the NFT art, or alternatively by embedding unique NFT art into a Bitcoin or other digital coin using ordinals.

The attachment of the certificated trust interest to new digital NFT technology provides underlying intrinsic value to support each unique series of CrowdCOIN tokens—the NFT art of which can be associated with special events, favorite teams or other things to which the holder has an emotional attachment, creating further value for the token.

APP CAT CrowdSOLUTIONS plug-ins are made available to marketing partners or CrowdDATA co-op Members (“Members”) for free. Users engage through the CrowdLIVE Interactive plug-ins and other CrowdSOLUTIONS features in marketing Partner/Member apps. Users have the opportunity to create anonymized data profiles and earn CrowdCOIN rewards as they engage and provide data through CrowdSOLUTIONS features. Data obtained can be used directly by marketing partners/Members and monetized through various means

Users are rewarded through their profile in CrowdCOIN in denominations of [250, 500 and 1,000]; CrowdCOIN are not envisioned to be tradeable.

CrowdCOINs are used to fill out CrowdCOIN Collection cards-akin to the famous G&H stamp collection card program; additional CrowdCOINs can be purchased to complete a CrowdCOIN Collection Card. Once a user has a completed a CrowdCOIN Collection card it can be redeemed for e-gift cards, partner merchandise or discounts. Additionally, a primary incentive for completing CrowdCOIN Collection cards will be to redeem them for commodity-backed NFT CrowdCOIN Tokens. CrowdCOIN NFT Tokens are issued in limited series and also be available for purchase using US Dollars and certain other fiat currencies.

### CrowdCOIN

APP CAT CrowdSOLUTIONS plug-ins are made available to marketing partners or CrowdDATA co-op Members (“Members”) for free. Users engage through the CrowdLIVE Interactive plug-ins and other CrowdSOLUTIONS features in marketing Partner/Member apps. Users have the opportunity to create anonymized data profiles and earn CrowdCOIN rewards as they engage and provide data through CrowdSOLUTIONS features Data obtained can be used directly by marketing partners/Members and monetized through various means

Users are rewarded through their profile in CrowdCOIN in denominations of [250, 500 and 1,000]; CrowdCOIN are not envisioned to be tradeable.

CrowdCOINs are used to fill out CrowdCOIN Collection cards-akin to the famous G&H stamp collection card program; additional CrowdCOINs can be purchased to complete a CrowdCOIN Collection Card. Once a user has a completed a CrowdCOIN Collection card it can be redeemed for e-gift cards, partner merchandise or discounts. Additionally, a primary incentive for completing CrowdCOIN Collection cards will be to redeem them for commodity-backed NFT CrowdCOIN Tokens. CrowdCOIN NFT Tokens are issued in limited series and also be available for purchase using US Dollars and certain other fiat currencies.

### NFT CrowdCOIN Tokens

Each NFT CrowdCOIN Token (“CCT”) is attached to a trust certificate that provides underlying intrinsic value to the token. Trust certificates are issued by the CrowdCOIN Trust, which will invest in commodities or liquid commodity exchange shares.

In an embodiment BTC is used as the underlying trust commodity asset. However, gold, silver, other precious metal or commodity can be used as the trust commodity assets. A variety of fractional trust certificates are available for partial units of the underlying trust commodity assets so as to able to create tokens across a range of values.

For example, trust certificates representing 1/20^{th}, 1/10^{th}, ½ and 1 BTC are made available to attach to NFT CrowdCOINs. Alternatively, trust certificates representing 1/10^{th}, ½ and 1 ounce of gold, silver or other precious metal or commodity are available to attach to NFT CrowdCOINs. The combination of the range of certificate value and variable value of the NFT art makes each series unique, distinguishing it from a fungible token or other form of payment.

Each CrowdCOIN series has unique serial number identifiers and is issued in a limited set quantity. CrowdCOINs can be purchased outright for fiat currency or together using fiat currency and CrowdCOIN rewards collection cards.

CrowdCOIN Token series are issued i) periodically (i.e., weekly) with unique designs that APP CATS or other partner creates and ii) from time-to-time as limited-edition series in conjunction with clients and marketing partners around special events, such as:

Sports teams/seasons: Pro sports, Playoff special edition (i.e., NHL/NBA/MLB/NFL Playoff Coins), Super Bowl, Collegiate teams, etc.
Special events: Olympics, Special Olympics, Red Bull Rampage, etc.
Theme parks, characters and other: Disney, Universal, Sea World, etc.

Limited-edition series can also have special experience access associated with them at an event. For example, holders of a limited-edition Super Bowl NFT might get access to special seats, pre-game or post-game activities. Holders of a special theme park related NFT might get special access to backstage special experience tours. Marketing partners/Members can pay a set-up fee to CrowdCOIN in connection with the issuance of special edition series.

### NFT CrowdCOIN Tokens Trading and Redemptions

CrowdCOIN Tokens can be traded by owners on exchanges like other NFTs. CrowdCOIN LLC earns via smart contract a commission upon each trade of a NFT Token. For Special edition series created with a marketing partner/Member around a special event, the commission is split between CrowdCOIN and the marketing partner/Member.

The NFT portion of a CrowdCOIN cannot be decoupled from the gold certificate other than if an owner seeks to redeem the token with the CrowdCOIN Trust—at which point the owner would retain the NFT and receive back either the underlying commodity certificates in an amount equal to the NAV (net asset value) of the Trust for the corresponding number of units/ounces represented by the associated certificate, minus a small redemption fee. For example, upon redemption of a BTC certificate, a holder would receive back BTC, and upon the redemption of a gold certificate, a holder would receive back gold bullion or tradeable gold exchange shares such as GLD SPDR ETFs.

Options for redemption of gold and other traditional commodity trust certificates can include a crypto token that allows holders to keep their redeemed value “on-chain” versus receiving back the off-chain commodity (BTC by nature is already “on-chain”).

Applicable redemption periods apply following the issuance of a CrowdCOIN NFT Token series (e.g., can't be redeemed within days of issuance and upon issuance (i.e., upon redemption liquid shares would be provided in [X] days). The net asset value of the Trusts will be calculated as the value of the underlying commodity per unit held by the Trust minus the applicable management fees.

### NFT CrowdCOIN Takens Backed by Trust Certificates

FIG. 9 is an illustration on NFT CrowdCOIN tokens backed by trust certificates. The example shows both BTC certificates and gold bullion certificates.

### NFT CrowdCOIN Takens Backed by Commodity-Redeemable Token

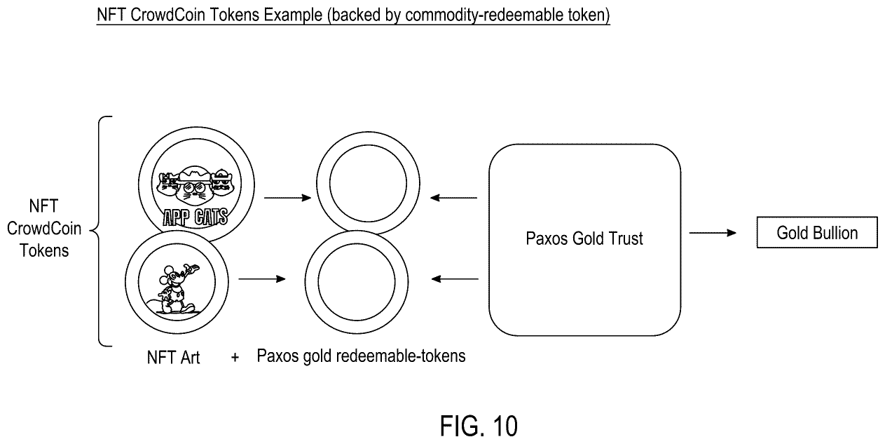

FIG. 10 is an illustration of NFT Tokens backed by commodity-redeemable tokens according to an embodiment. A commodity-redeemable token is used rather than a trust certificate to attach to the NFT art to form each NFT CrowdCOIN token to provide the underlying intrinsic value to the token. For example, the PAX Gold token (PAXG) is issued by Paxos and backed by the Paxos Trust Company, which is a regulated financial institution and a qualified custodian regulated by the New York State Department of Financial Services. Each PAXG token represents one troy ounce of physical gold and is instantly redeemable for the underlying physical gold bullion commodity. PAXG tokens are available for purchase in increments of 0.01 troy ounce of gold

The combination of the available range of values of the PAXG tokens and variable value of the NFT art make each series unique, distinguishing it from a fungible token or form of payment.

### NFT CrowdCOIN Dual Tokens

In an embodiment the standard commodity certificates backing NFT CrowdCOIN tokens are equal to the NAV of the Trust (net of expenses) and will vary in value based on prices of the underlying commodity in the market-whether BTC, gold, silver or other precious metal or commodity. For this reason, the inherent volatility of the underlying commodities do not make them suitable to be used as a medium of exchange.

As a solution to this problem, a dual-purpose certificate is created to be divisible into two primary component tokens that are detachable and split the value of a quantum of the underlying commodity in two, with a fixed base component and a variable upside piece. For example, using gold as the underlying commodity:
A Base unit, which would be worth the first $1,000 of value of an ounce of gold (an ounce of gold trades for ˜$2,000 today), plus
A Top unit, which would represent all of the value of an ounce of gold above $1,000; this will vary daily as the market fluctuates and, therefore, is more speculative in nature.
   the NFT art would be attached to the Top unit specifically.
The Base unit is detachable, and its value remain largely stable over time-allowing it to be used as a future medium of exchange
   This creates a stable-type coin that is not reliant on the US dollar or other fiat currency.

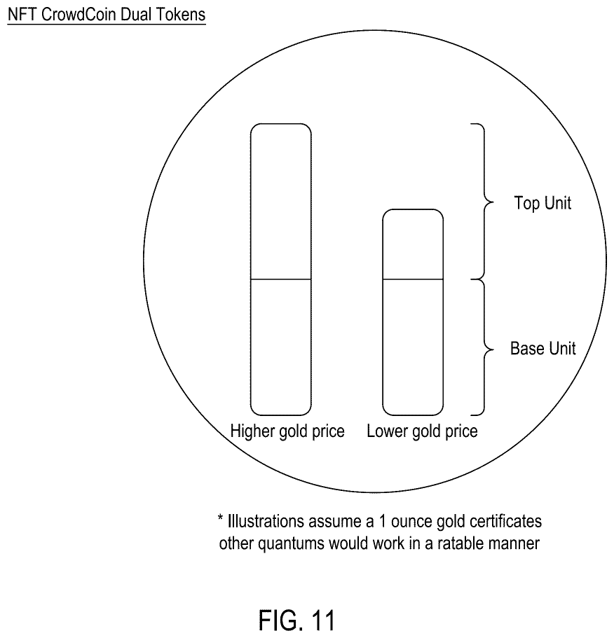

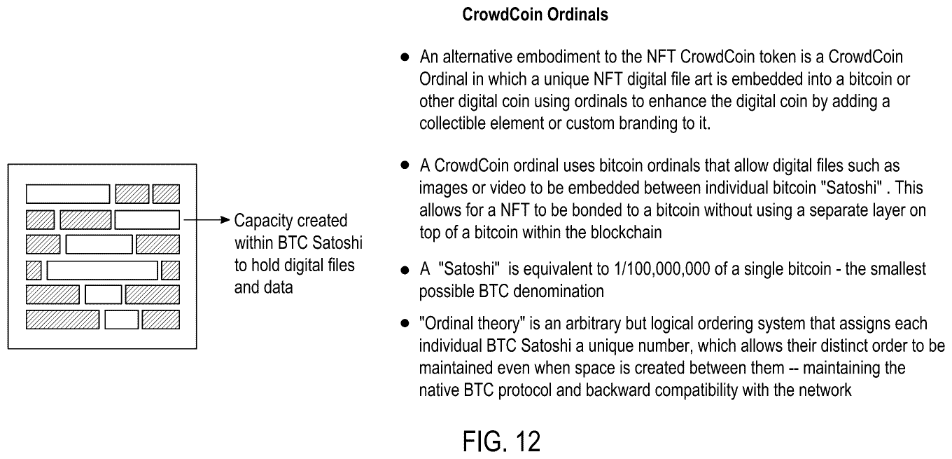

FIG. 11 is a diagram illustrating dual tokens.

One possible use case follows:
Mobile Telecom Partner integrates CrowdSOLUTIONS plug-in into its marketing app in which customers are offered special deals and opportunities weekly.
Once a week, Mobile Telecom Partner will host a CrowdLIVE INTERACTIVE event for customers within its app. During this time, Mobile Partner's own business partners (“Weekly Partners”) have an opportunity to demo a new product or service with a call-to-action for the users.
Users who engage and participate in the call-to-action have the opportunity to earn an exclusive CrowdCOIN to add to their CrowdCOIN Collections.
Additional CrowdCOINs can be purchased to complete a CrowdCOIN Collection Card
Each week a new NFT digital asset will be designed around Weekly Partner's-related art that will be made available in limited, unique series of NFT CrowdCOIN Tokens
Both Mobile Marketing Partner and Weekly Partners promote the limited unique NFT CrowdCOIN Tokens to their user bases

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for case of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to conduct a goal-directed semantic search. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which will be set forth in the forthcoming claims.

What is claimed is:

1. A system for providing and administering access to tokens, the system comprising:
a platform including multiple processors, servers, and memory components;
a plug-in software component that communicates with multiple application providers and multiple application users;
network services supported by the platform that include allowing users to participate in obtaining and trading multiple types of tokens, wherein the types of tokens comprise one or more types chosen from a group comprising,
non-fungible tokens (NFTs); and
NFTs that include an attached trust certificate.

2. The system of claim 1, further comprising multiple databases that store and make available data received from both the application providers and the application users.

3. The system of claim 1, wherein the group of types of tokens further comprises:
NFT's that include an attached dual-purpose trust certificate that is divisible such that a quantum of value of assets is divisible into detachable units.

4. The system of claim 3, wherein the components comprise a fixed base unit and a variable top unit.

5. The system of claim 3, wherein the top unit represents all of the value of a Bitcoin (BTC) above a chosen dollar value.

6. The system of claim 5, wherein NFTs are attached to the top unit.

7. The system of claim 6, wherein commodity-backed tokens are attached to an NFT art form, in the form of unique collectible coin series.

8. The system of claim 7, wherein the collectible coins series is a way to combine storage of value on various forms held in trust and attached to an NFT art form.

9. The system of claim 8, wherein the various forms include without limitation Bitcoin and precious metal.

10. A method for providing and administering access to tokens, the system comprising:
network services supported by a hardware platform that include allowing users to participate in obtaining and trading multiple types of tokens, wherein the types of tokens comprise one or more types chosen from a group comprising,
non-fungible tokens (NFTs); and
NFTs that include an attached trust certificate.

11. The method of claim 10, further comprising multiple databases that store and make available data received from both the application providers and the application users.

12. The method of claim 10, wherein the group of types of tokens further comprises:
NFTs that include an attached dual-purpose trust certificate that is divisible such that a quantum of value of assets is divisible into detachable units.

13. The method of claim 12, wherein the components comprise a fixed base unit and a variable top unit.

14. The method of claim 13, wherein the top unit represents all of the value of a Bitcoin (BTC) above a chosen dollar value.

15. The method of claim 14, wherein NFTs are attached to the top unit.
